(19) United States
(12) Patent Application Publication
(10) Pub. No.: US 2017/0267909 A1
(43) Pub. Date: Sep. 21, 2017

(54) Methods and Materials for Improving Wellbore Stability in Laminated Tight Carbonate Source-Rock Formations

(71) Applicant: BAKER HUGHES INCORPORATED, Houston, TX (US)

(72) Inventors: GUODONG JIN, Katy, TX (US); TIANPING HUANG, Spring, TX (US); HASAN KESSERWAN, Beirut (LB); HECTOR GONZALEZ PEREZ, Madrid (ES); PRAHLAD YADAV, Dist-Jabalpur M.P. (IN); GAURAV AGRAWAL, Aurora, CO (US)

(73) Assignee: BAKER HUGHES INCORPORATED, Houston, TX (US)

(21) Appl. No.: 15/072,584

(22) Filed: Mar. 17, 2016

(51) Int. Cl. C09K 8/035; G01V 11/00; G01N 13/00; E21B 21/00; E21B 49/00

(52) U.S. Cl. CPC C09K 8/035; E21B 21/003; E21B 49/005; G01N 13/00; G01V 11/00

(57) ABSTRACT

The stability of subterranean, laminated, carbonate-containing formations that have strongly hydrophilic-wet surfaces is improved by introducing into the formation an aqueous fluid having dispersed therein relative permeability modifiers (RPMs). The RPMs are designed to enter the fractures and gaps between the layers in the formation and alter their surface wettability to inhibit water from further entering into the shale rock, thereby improving stability.

### TECHNICAL FIELD

The present invention relates to methods and/or compositions for drilling through subterranean, laminated, carbonate-containing formation during hydrocarbon recovery operations, and more particularly relates, in one non-limiting embodiment, to methods and/or compositions for drilling through subterranean, laminated, carbonate-containing formation during hydrocarbon recovery operations that improve wellbore stability.

### TECHNICAL BACKGROUND

Drilling fluids are categorized into water-based mud and oil-based mud. Water based drilling fluids may be designed with water and polymer that is needed to increase viscosity for carrying the cuttings and for fluid loss control, monovalent and multivalent salts for shale inhibition, different bridging material and weighting materials (e.g. barium sulfate, manganese tetroxide, hematite) for providing the desired mud weight. Drill-in fluids are special fluids designed exclusively for drilling through the reservoir section of a subterranean formation. The reasons for using specially designed drilling fluids include, but are not necessarily limited to, (1) to drill the reservoir zone successfully, which is often a long, horizontal drain hole, (2) to minimize damage of the near-wellbore region and maximize the eventual production of exposed zones, and (3) to facilitate the necessary well completion. Well completion may include complicated procedures. Typically, drill-in fluids may resemble completion fluids. Drill-in fluids may be brines containing only selected solids of appropriate particle size ranges (for instance, salt crystals or calcium carbonate) and polymers. Usually, additives needed for filtration control and cuttings carrying are present in a drill-in fluid. As noted, drill-in fluids may contain filtration control additives to inhibit or prevent loss of the drill-in fluid into the permeable formation. Fluid loss involves the undesired leakage of the liquid phase of a drill-in fluid containing solid particles and complete losses without any return into the formation matrix. The resulting buildup of solid material or filter cake against the borehole wall may be undesirable, as may be the penetration of the filter cake into the formation. The removal of filter cake, which sometimes must be done by force, may often result in irreparable physical damage to the near-wellbore region of the reservoir. Fluid-loss additives are used to control the process and avoid potential damage of the reservoir, particularly in the near-wellbore region. Specially designed fluids may be used to be placed next to the reservoir and make a seal. This fluid may be different than the drill-in fluid and is often referred to as a “sealing or lost circulation pill”.

Unconventional source-rock reservoirs are geologically and petrophysically complex. Wellbore instability or hole enlargement issues have been experienced during the drilling of horizontal wells in laminated tight carbonate source rock formations (in one non-limiting embodiment, Middle East carbonate source rocks). It has occurred that there were no drilling issues on the vertical portion of the well where the holes were in gauge. However, the horizontal portions of the wells were substantially broken out and the holes were over gauge when using water based muds (WBMs). The horizontal laterals of the wells are targeted for the highest total organic carbon (TOC) interval to maximize hydrocarbon production. The geo-mechanical model and real-time observations indicated that the mud weight should be sufficient to maintain wellbore stability due to the far-field stress. These formations have a relatively small amount (less than 10%) of clay minerals (or reactive clays) implying that chemical reactions are not the cause of borehole instability. There are many unconventional carbonate shale hydrocarbon reservoirs around the world, such as Middle East unconventional source-rocks Tuwaiq Mountain and Jurassic Hanifa formations, North American Eagle Ford and Bakken Shale formations, and the like.

It would thus be desirable to discover a water-based drilling fluid or drill-in fluid or other fluid which would be able improve wellbore stability.

### SUMMARY

There is provided in one non-restrictive version, a method for improving wellbore stability in a subterranean, laminated, carbonate-containing formation, where the method includes obtaining information about the wettability characteristics and distribution of those characteristics in the formation and information about widths of fractures and gaps between layers in the formation and their distribution. The method further includes designing relative permeability modifier (RPM) particles by determining an average particle size distribution (PSD) to fit the widths of the fractures and the gaps and determining a suitable RPM material for the RPM particles. The method further involves introducing into the formation an aqueous fluid comprising water and a plurality of the RPM particles dispersed in the aqueous fluid. The RPM particles enter the fractures and gaps and the RPM material swells upon contact with water to at least partially fill the fractures and gaps.

In another non-limiting embodiment there is provided a method for improving wellbore stability in a subterranean, laminated, carbonate-containing formation, where the method includes measuring subsurface core samples and taking downhole logging measurements, and determining from the subsurface core samples and downhole logging measurements information about the mineralogy wettability characteristics and distribution of those characteristics in the formation, and determining information about widths of fractures and gaps between layers in the formation and their distribution, where the fractures and gaps have an average size range between about 0.5 micron and about 5 mm. The method further includes designing RPM particles by determining an average PSD to fit the widths of the fractures and the gaps and determining a suitable RPM material for the RPM particles. The method further involves introducing into the formation an aqueous fluid comprising water and a plurality of the RPM particles dispersed in the aqueous fluid. The RPM particles enter the fractures and gaps and the RPM material swells upon contact with water to at least partially fill the fractures and gaps.

### BRIEF DESCRIPTION OF THE DRAWINGS

FIGS. 1A, 1B, and 1C are schematic illustrations of how rock grains may be water-wet, mixed-wet and oil-wet, respectively; and

FIG. 2 is a series of photographs showing a subterranean rock sample with thinly-layered structure and plugs taken from such a rock sample;

FIG. 3 is a micro-computed tomography (micro-CT) image of one horizontal plug;

FIG. 4 is a Focus-Ion Beam SEM technique image of a very tiny rock sample;

FIG. 5 is an enlarged Focus-Ion Beam SEM image of a very tiny rock sample showing an inorganic matrix that is hydrophilic wet and a kerogen region that is hydrophobic wet where the black color shows kerogen pores;

FIG. 6 is a micro-CT image of a cross-section of a horizontal plug showing relatively larger and relatively smaller fracture gaps between thin rock layers;

FIG. 7 is a schematic flow chart of one implementation of the method described herein for improving wellbore stability in a subterranean, laminated, carbonate-containing formation;

FIG. 8 is a NMR T2 distribution of incremental porosity as a function of T2 for water imbibition;

FIG. 9 is a NMR T2 distribution of incremental porosity as a function of T2 for oil imbibition;

FIG. 10 is a schematic graph of fracture/gap size distribution such as would be determined from core samples or downhole logging measurements showing percentage of fracture/gaps as a function of the width of the fracture/gaps;

FIG. 11 is a schematic illustration of two gap/fractures of different widths each having a relative permeability modifier (RPM) particle or respective matched sizes in the respective gap/fracture;

FIG. 12 is a schematic illustration of two gap/fractures of different widths each having RPM particles of the same relatively small size in the respective gap/fracture to change the wettability of the gap/fracture surface from water-wet to oil-wet so that it is difficult for water to invade the gaps;

FIG. 13A is a schematic illustration of two gap/fractures of different widths each having RPM particles of the same relatively small size, and of a structure of a RPM layer on a core, in the respective gap/fracture showing the particles before activation;

FIG. 13B is a schematic illustration of two gap/fractures of different widths each having RPM particles of the same relatively small size, and of a structure of a RPM layer on a core, in the respective gap/fracture as shown in FIG. 13A showing the particles after activation by water contact that caused the RPM layer to swell, blocking water invasion; and

FIG. 13C is a schematic illustration of two gap/fractures of different widths each having RPM particles of the same relatively small size, and of a structure of a RPM layer on a core, in the respective gap/fracture showing the particles after activation by water contact as in FIG. 13B, but after the water has been replaced by oil and the RPM layer has contracted or shrunk back to a “non-activated” size to permit oil to pass through the gap/fractures.

It will be appreciated that many of the Figures are schematic illustrations that are not to scale and which have had certain features exaggerated for clarity, which exaggerations and lack of scale do not limit the methods and compositions described herein.

### DETAILED DESCRIPTION

It has been discovered that relative permeability modifiers (RPMs) may be uniformly dispersed in aqueous fluids, in one non-limiting embodiment a drilling fluid for drilling or for fracking horizontally through laminated tight carbonate source rock zones can improve wellbore stability. The method includes:
estimating the fracture/gap widths between layers in laminated tight carbonate source rock from the laboratory and/or downhole NMR (nuclear magnetic resonance) T2 measurements, or micro-computed tomography (micro-CT) x-ray images or similar technique;
based on the fracture/gap width information, designing the sizes of particles containing RPM materials and adding them into the WBM fluids, which RPMs then block water entering the fractures/gaps between thin-layers once the RPM particles are introduced into the fracture/gaps;
design particles coated with or at least partially coated with RPM materials (or wholly made of RPM materials) when these coated particles with WBM enters into the fractures/gaps, the coated materials after activation will swell when water comes in contact with them and shrink when oil comes in contact with them, thus blocking water entering the fractures/gaps permitting oil to pass; and
where in the design of RPM materials, they will attach to the surface of hydrophilic-wet fractures/gaps between the thin layers, and alter the surface wettability to inhibit water further entering into deep shale rock, which can reduce the tendency of wellbore instability.

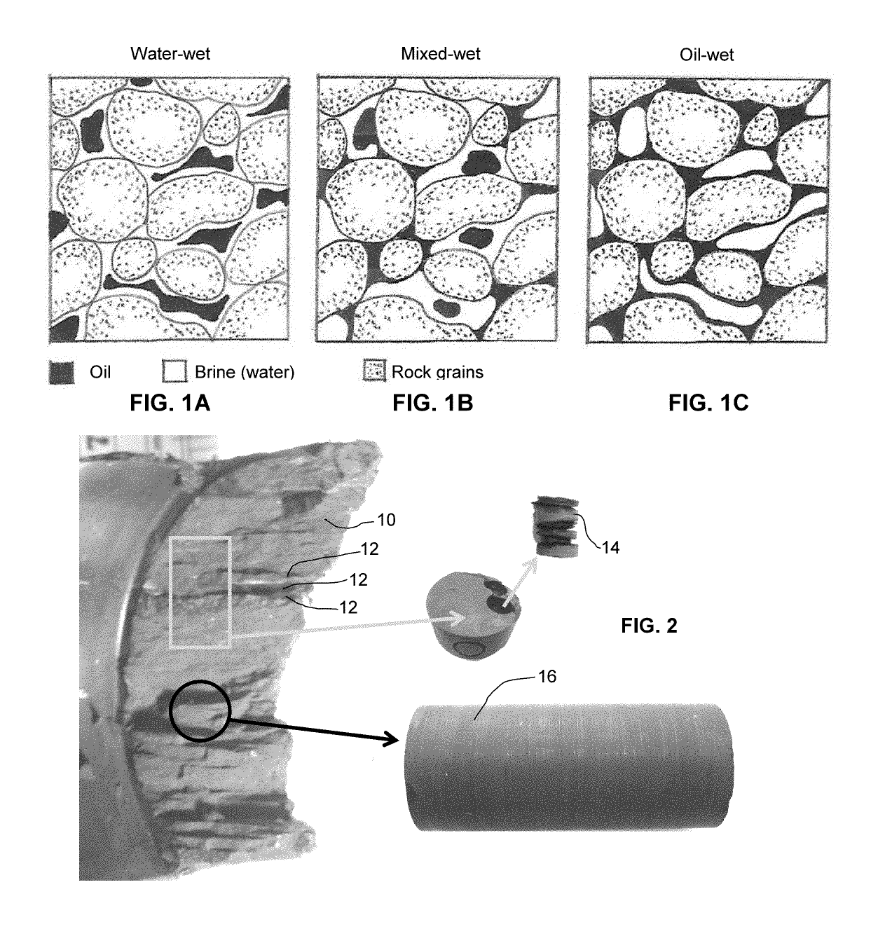

Wettability describes the preference of a solid to be in contact with one fluid rather than another. For example, if a pore surface is hydrophilic wet, water will be distributed on the surface, while oil will be present in the middle part of the pore. In this case, water can be easily imbibed into the rock pore system, while oil will not. If the pore surface is hydrophobic wet, oil will be distributed on the surface, while water will be present in the middle part of the pore. In this second scenario, oil can be easily adsorbed into the rock pore system. FIG. 1A is a schematic illustration of how rock grains may be water-wet showing the rock grain surfaces being primarily contacted with water or brine (white). FIG. 1C is a schematic illustration of how rock grains may be oil-wet showing the rock grain surfaces being primarily contacted with oil (black). Similarly, FIG. 1B is a schematic illustration of how rock grains may be “mixed wet” showing the rock grain surfaces being contacted with both water or brine and oil.

Conventional formations are usually assumed to be hydrophilic wet or hydrophobic wet for the whole system. However, for unconventional shale, it is a mixed-wet system (see FIG. 1B). The kerogen region is hydrophobic wet and the inorganic matrix is hydrophilic wet. Both water and oil can imbibe into the source rock. Depending on mineral amount, distribution and connectivity, water and oil will invade the system through different paths and in different amounts.

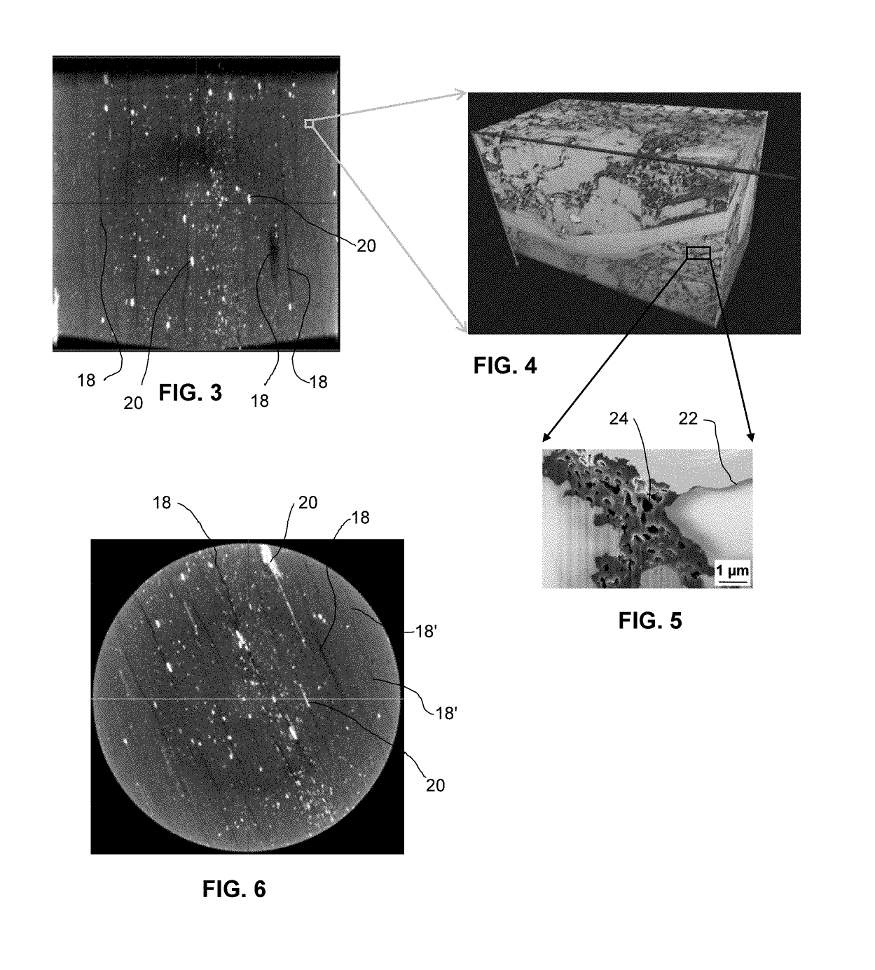

In more detail, shale formations are mainly composed of thinly layered sequences of aligned microscopic clay platelets. FIG. 2 presents an enlarged photograph of a shale sample 10 in which are displayed thin layers 12. A vertical plug 14 is drilled perpendicularly to the bedding or thin layers. A horizontal plug 16 is drilled parallel to the bedding or thin layers. Recent study of cores taken from Middle East found carbonate source rocks that were very thinly layered, high TOC and very little amount of clay. FIG. 3 is a micro-computed tomography (micro-CT) image of one horizontal plug. Gaps/fractures 18 between the thin layers are seen as the dark lines. The white parts are filled minerals 20 within the gap/fractures 18. FIG. 6 is a micro-CT image of a cross-section of a horizontal plug such as 16 showing relatively larger 18 and relatively smaller fracture gaps 18′ between thin rock layers, also showing filled minerals 20 within the gap/fractures 18 and 18′.

A small part of a horizontal plug 16, such as that in the micro-CT image of FIG. 3, is enlarged as a Focus-Ion Beam SEM technique image of a very tiny rock sample illustrated in FIG. 4. A small portion of the FIG. 4 image is enlarged showing an inorganic matrix 22 that is hydrophilic wet and a kerogen region 24 that is hydrophobic wet where the black color shows kerogen pores. FIG. 5 may be compared with FIGS. 1A, 1B, and 1C to see the similarities.

For laminated tight carbonate source rock such as those in Middle East and elsewhere, it has been discovered from experiments that it has very high TOC, which is mainly located in the kerogen region (see, e.g. FIG. 5) and very little clay minerals (less than 10 wt %). In geology “tight” describes a relatively impermeable reservoir rock from which hydrocarbon production is difficult, often because of the smaller grains or matrix between larger grains, or as often the case for shale reservoirs; they may be tight because they consist predominantly of clay-sized grains. As noted, it is believed that the minerals are distributed within the gaps/fractures between the thin layers. The kerogen regions 24 are hydrophobic wet, and can easily absorb oil. The inorganic matrix and gaps/fractures are hydrophilic wet and can take water easily. In one non-limiting explanation, it is believed that the low amount of clays distributed within the gaps and fractures between the thin layers play a role in taking water into the formation, increasing pore pressure, and reducing the effective stress, therefore resulting in wellbore instability. Thus, it can be helpful to know if the gap, fracture, and/or pore surfaces are mainly hydrophilic-wet, which takes a lot of water and increases the pore pressure. This will reduce formation effective stress, resulting in wellbore instability.

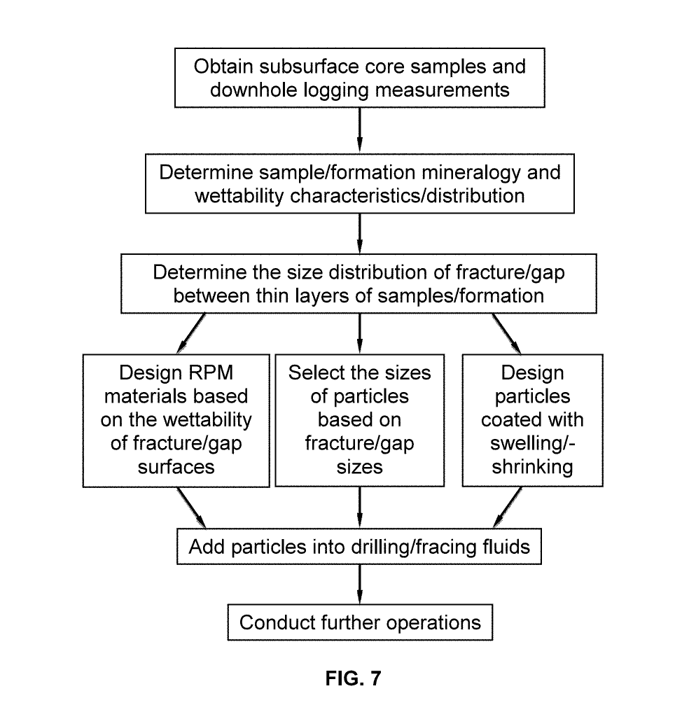

It has also been discovered that an approach such as that outlined in FIG. 7 can help improve wellbore stability in a particular subterranean, laminated, carbonate-containing formation. Briefly the method includes obtaining information about the wettability characteristics and distribution of those characteristics in the formation, as well as information about widths of fractures and gaps between layers in the formation and their distribution. Using that information, relative permeability modifier (RPM) particles are designed by determining an average particle size distribution (PSD) to fit the widths of the fractures and the gaps and determining a suitable RPM material for the RPM particles. An aqueous fluid is designed which comprises water and a plurality of the RPM particles dispersed in the aqueous fluid. This aqueous fluid is introduced into the formation where the RPM particles enter the fractures and gaps and the RPMs swell upon contact with water to at least partially fill the fractures and gaps. Whether or not the methods described herein should be implemented will not depend upon a specific value of widths of fractures or gaps; instead, it will be a size distribution. The range could be nanometer to micrometer. The method is designed to block water from getting into the gaps and fractures between the layers. Even if water invades partially into the gaps and/or fractures, the RPM particles will change the wettability of the gap and/or fracture surfaces from water-wet to oil-wet (see FIG. 11 and the explanation below). Thus, water will not easily invade the formation and wellbore stability will be improved.

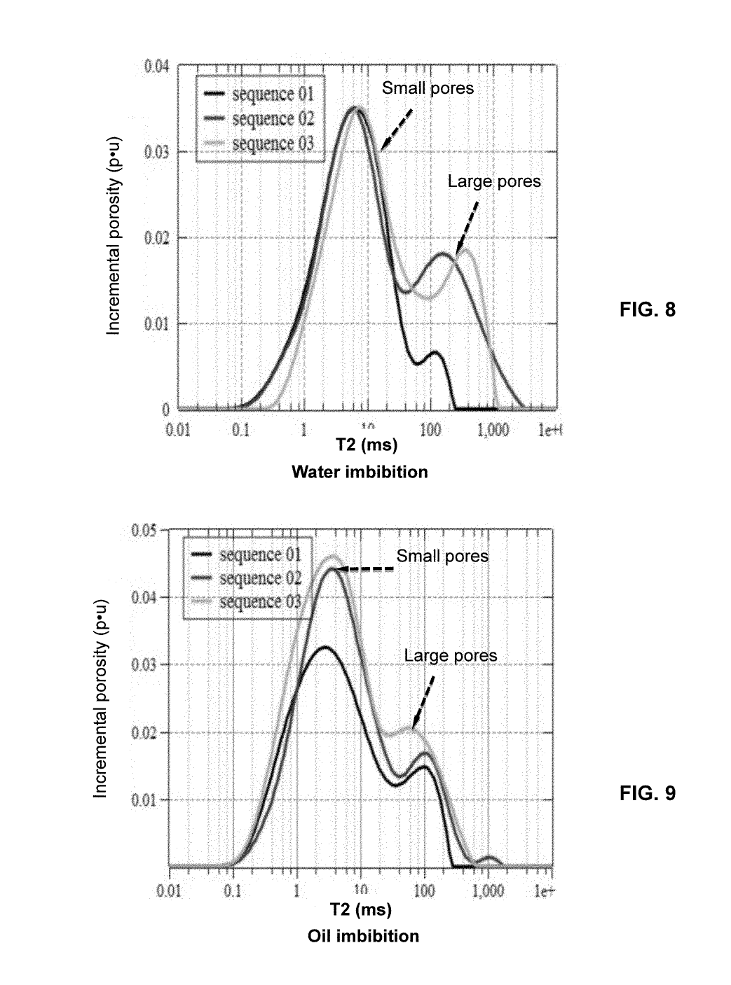

FIG. 8 presents a NMR T2 distribution of incremental porosity as a function of T2 for water imbibition, and FIG. 9 presents a NMR T2 distribution of incremental porosity as a function of T2 for oil imbibition, for two twin plugs, respectively. These analyses tell how much water, or oil, respectively, invades the rock samples. NMR T2 distribution also presents the pore sizes: from left to right (T2 increases) pore size increases. FIG. 8 shows the amount of water imbibed into the system with time. It shows that water invades both small and large pores. However, with time increasing, there is no water increase in the small pores, while water continues to invade in the large pores, which are believed to be the gaps or fractures between thin layers. FIG. 9 presents different behavior when the other twin plug is contacted with oil: oil continues to invade in the small pores, with no increase in the large pores.

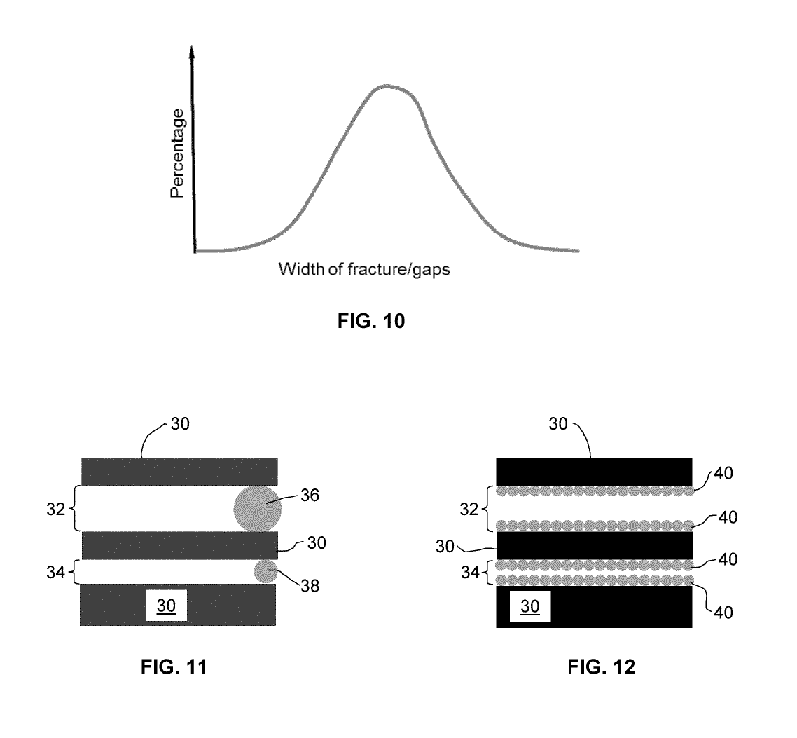

FIG. 10 presents a schematic graph of fracture/gap size distribution such as would be determined from core samples or downhole logging measurements showing percentage of fracture/gaps as a function of the width of the fracture/gaps. It will be appreciated that the fracture/gaps are a distribution over a range of widths; that is, any given formation does not have only a small range of gap/fracture widths, but instead has a distribution of widths.

FIG. 11 is a schematic illustration of two gap/fractures 32 and 34 within the laminated carbonate-containing formation 30 of different widths each having a relative permeability modifier (RPM) particle 36 of respective matched sizes in the respective gap/fracture. Relatively larger RPM particle 36 has swollen to fit within wider gap/fracture 32, whereas relatively smaller RPM particle 38 has swollen to fit within wider gap/fracture 34. In this non-limiting embodiment, the RPM particles 36 and 38 are solid RPM material; that is, there is no solid core.

FIG. 12 is a schematic illustration of two gap/fractures of different widths, 32 and 34 as in FIG. 11, except that the surfaces of the gap/fractures 32, 34 are covered by RPM particles 40 of the substantially same relatively small size, or at least about the same size, in the respective gap/fracture to change the wettability of the gap/fracture surface from water-wet to oil-wet so that it is difficult for water to invade the gaps. The water-hydrolyzed polymers of the RPM particles 40 are expected to attach to the water-wet pore surfaces, such as through van der Waals association forces, to hold the RPM particles 40 or RPM-coated particles in place.

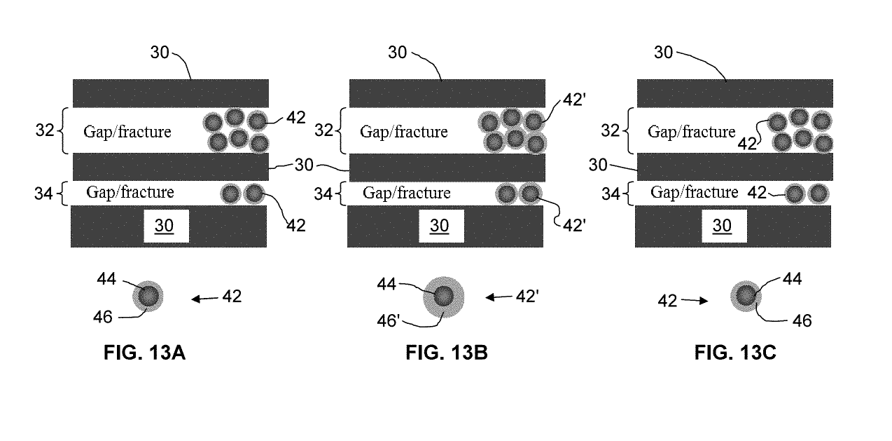

Shown in FIG. 13A is a schematic illustration of two gap/fractures 32 and 34 of different widths each having RPM particles 42 of substantially the same relatively small size, and of a structure of a RPM layer 46 on a core 44, in the respective gap/fracture 32 and 34 showing the particles before activation, that is, before contact with water and swelling. Shown in FIG. 13B is a schematic illustration of the two gap/fractures 32 and 34 of different widths of FIG. 13A each having RPM particles 42′ of the same relatively small size, and of a structure of a RPM layer 46′ on a core 44, in the respective gap/fractures 32 and 34 except that the particles 42′ are shown in their form after activation by water contact that caused the RPM layer 46′ to swell, blocking water invasion into gap/fractures 32 and 34. Lastly as shown in FIG. 13C is a schematic illustration of the two gap/fractures 32 and 34 of different widths of FIGS. 13A and 13B, each having RPM particles 42 of the same relatively small size, and of a structure of a RPM layer 46 on a core 44, in the respective gap/fracture 32 and 34 showing the particles after activation by water contact as in FIG. 13B, but then also after the water has been replaced by oil and the RPM layer 46 has contracted or shrunk back to a “non-activated” size to permit oil to pass through the gap/fractures 32 and 34 to be produced through the wellbore.

In more detail, information about the wettability characteristics and distribution of those characteristics in the formation and information about widths of fractures and gaps between layers in the formation and their distribution may be obtained by measuring subsurface core samples and taking downhole logging measurements, determining from the subsurface core samples and downhole logging measurements information about the mineralogy wettability characteristics and distribution of those characteristics in the formation, and/or determining information about widths of fractures and gaps between layers in the formation and their distribution. In one non-limiting embodiment, the measurements are taken by a method selected from the group consisting of laboratory nuclear magnetic resonance (NMR), micro-computed tomography (micro-CT), microscopy, downhole logging measurements, and combinations thereof. From micro-CT images or microscopy, the widths of the fractures or gaps can be determined directly.

Without wanting to be limited to any particular interpretation, the fractures and gaps have an average size range between from about 0.5 micron independently to about 5 mm; alternatively from about 1 micron independently to about 2 mm; and in another non-limiting embodiment about 5 micron independently to about 1 mm. It should be appreciated that the use of the term “independently” as used herein with respect to a range means that any lower threshold may be combined with any upper threshold to give a different, acceptable range.

As noted, the RPM particles are designed to have a particle size distribution (PSD) that will permit the RPM particles to enter the gaps and fractures when they are in their non-activated size; that is, when the RPM material is not swollen or not very swollen. Thus, the size ranges will be less than those discussed immediately above for the gaps and fractures. In one non-limiting embodiment the PSD of the RPM particles is about 30% of or smaller than the average size of the fractures and gaps; alternatively about 20% of or smaller than the average size of the fractures and gaps, and in a different non-restrictive version about 10% of or smaller than the average size of the fractures and gaps. Nevertheless, it is expected that upon contact with water, the RPM material will swell sufficiently to block water passage through the gaps and fractures, stabilizing the shale. If and when the water is replaced by oil or other hydrocarbon, the RPM material will shrink down to its previous size, or at least sufficiently close to its previous size, to permit the oil or hydrocarbon to pass through the gaps and/or fractures to be produced. In one non-limiting embodiment the RPM particles have a PSD between about 100 nanometer independently to about 500,000 nanometers; alternatively between about 200 nanometers independently to about 100,000 nanometers; and in a different non-restrictive version between about 300 nanometer independently to about 5000 nanometers; and in another non-limiting embodiment from about 500 nm independently to about 3000 nm.

The RPM particles may be made completely of a suitable RPM material, such as those schematically illustrated in FIGS. 11 and 12 at 36 and 38, or may be a coating 46 of suitable RPM material on a suitable solid core 44, such as those schematically illustrated in FIGS. 13A, 13B, and 13C at 42. While it is expected that the cores would in most cases be completely covered by a coating or layer of RPM material, it would be acceptable if the RPM material only partially coated the cores. There is no particular suitable coating thickness for the RPM layers. The only requirement for them is that when they are adsorbed or otherwise present on the surface of the pores, gaps and fractures that after activation, they will change the gap surface wettability from water-wet to oil-wet.

Suitable RPM materials include, but are not necessarily limited to homopolymers and copolymers of acrylamide, sulfonated or quaternized homopolymers and copolymers of acrylamide, polyvinylalcohols, polysiloxanes, hydrophilic natural gum polymers and chemically modified derivatives thereof; crosslinked homopolymers and copolymers of acrylamide, crosslinked sulfonated or quaternized homopolymers and copolymers of acrylamide, crosslinked polyvinylalcohols, crosslinked polysiloxanes, crosslinked hydrophilic natural gum polymers and chemically modified derivatives thereof; copolymers having a hydrophilic monomeric unit, where the hydrophilic monomeric unit is selected from the group consisting of ammonium and alkali metal salt of acrylamidomethylpropanesulfonic acid, a first anchoring monomeric unit based on N-vinylformamide and a filler monomeric unit, where the filler monomeric unit is selected from the group consisting of acrylamide and methylacrylamide; and copolymers of vinylamide monomers and monomers containing ammonium or quaternary ammonium moieties, copolymers of vinylamide monomers and monomers comprising vinylcarboxylic acid monomers and/or vinylsulfonic acid monomers, and salts thereof, and these copolymers comprising a crosslinking monomer selected from the group consisting of bis-acrylamide, diallylamine, N,N-diallylacrylamide, divinyloxyethane, divinyldimethylsilane. Suitable core materials include, but are not necessarily limited to, ceramic beads, glass, sand (the most common component of which is silica, i.e. silicon dioxide, SiO₂), clay, walnut shell fragments, other nut shells, metal beads, aluminum pellets, alumina, bauxite grains, sintered bauxite, sized calcium carbonate, gravel, resinous particles, nylon pellets, other polymer materials, and combinations thereof.

When the RPM particles are introduced into the formation to place the RPM particles into the gaps, fractures and pores of the formation, an aqueous fluid is used that comprises water or brine and a plurality of the RPM particles dispersed in the aqueous fluid. Suitable water includes, but is not necessarily limited to tap water and sea water. In one non-limiting embodiment the proportion of RPM particles dispersed in the aqueous fluid ranges from about 1 independently to about 30% by weight; alternatively from about 10 independently to about 20% by weight.

The carbonate content of the subterranean, naturally-fractured, carbonate-containing formation ranges from about 30 independently to about 100% by weight; alternatively from about 50 independently to about 80% by weight. Further, the carbonates generally present in the subterranean, naturally-fractured, formation are calcium carbonate/magnesium carbonate or calcium magnesium carbonate although other types of carbonate may be present. By “naturally-fractured” is meant that the formation contains naturally occurring fractures prior to any stimulation operations, such as, but not limited to, acid fracturing, matrix fracturing, and the like. Nevertheless, in one non-limiting embodiment the methods described herein can be practiced on a subterranean, carbonate-containing formation that has been stimulated by a fracturing operation.

No particular process step is necessary to ensure that the RPM particles will enter and/or contact the fractures, gaps, vugs, pores or holes. Typically, pumping the aqueous fluid containing the dispersion of RPM particles against the porous rock will cause the particles to engage, penetrate, and otherwise contact the gaps, vugs and holes.

In one non-limiting embodiment, the RPM particles are a crosslinked polymer and are dried or at least partially dried. The swelling rate of the RPM particles in the WBM that is used to transport them to the gaps, holes, and vugs can be designed so that the RPM does not swell at all, or does not appreciably swell before the RPM particles engage, penetrate, and otherwise contact the gaps, vugs and holes. In another non-limiting embodiment, the swelling of the RPM material of the RPM particles can be prevented or inhibited by the WBM having a suitable salt therein. Suitable salts include, but are not necessarily limited to, NaCl, KCl, NH₄Cl, CaCl₂, ZnCl₂, NaBr, KBr, CaBr₂, ZnBr₂, NaHCO₃, potassium formate, cesium formate, and combinations thereof.

In the foregoing specification, the invention has been described with reference to specific embodiments thereof, and has been demonstrated as effective to provide methods and compositions to stabilize wellbores in a subterranean, laminated and/or tight, carbonate-containing formations. However, it will be evident that various modifications and changes can be made thereto without departing from the broader scope of the invention as set forth in the appended claims. Accordingly, the specification is to be regarded in an illustrative rather than a restrictive sense. For example, specific combinations of analytical methods of obtaining and examining core samples, downhole logging, determining information about mineralogy wettability characteristics and distribution of those characteristics in the formation, determining information about the widths of fractures and gaps between layers and their distribution, designing RPM particles, the PSD of the RPM particles, the nature of the RPM material with which the RPM particles are made, the proportion of RPM particles in the aqueous fluid used to introduce the RPM particles, and other components falling within the claimed parameters, but not specifically identified or tried in a particular method or aqueous fluid, are anticipated to be within the scope of this invention. Similarly, it is expected that the drilling methods may be successfully practiced using somewhat different sequences, temperature ranges, and proportions than those described or exemplified herein.

The present invention may suitably comprise, consist of or consist essentially of the elements disclosed and may be practiced in the absence of an element not disclosed. For instance, there may be provided a method for improving wellbore stability in a subterranean, laminated, carbonate-containing formation, where the method consists essentially or consists of obtaining information about the wettability characteristics and distribution of those characteristics in the formation and information about widths of fractures and gaps between layers in the formation and their distribution; designing relative permeability modifier (RPM) particles by determining an average particle size distribution (PSD) to fit the widths of the fractures and the gaps and determining a suitable RPM material for the RPM particles; then introducing into the formation an aqueous fluid comprising, consisting essentially of, or consisting of water and a plurality of the RPM particles dispersed in the aqueous fluid; and where the RPM particles enter the fractures and gaps and the RPM material swells upon contact with water to at least partially fill the fractures and gaps.

As used herein, the terms “comprising,” “including,” “containing,” “characterized by,” and grammatical equivalents thereof are inclusive or open-ended terms that do not exclude additional, unrecited elements or method acts, but also include the more restrictive terms “consisting of” and “consisting essentially of” and grammatical equivalents thereof. In another non-limiting embodiment, the words “comprising” and “comprises” as used throughout the claims is interpreted “including but not limited to”.

As used herein, the term “may” with respect to a material, structure, feature or method act indicates that such is contemplated for use in implementation of an embodiment of the disclosure and such term is used in preference to the more restrictive term “is” so as to avoid any implication that other, compatible materials, structures, features and methods usable in combination therewith should or must be, excluded.

As used herein, the singular forms “a,” “an,” and “the” are intended to include the plural forms as well, unless the context clearly indicates otherwise.

As used herein, the term “and/or” includes any and all combinations of one or more of the associated listed items.

As used herein, relational terms, such as “first,” “second,” “top,” “bottom,” “upper,” “lower,” “over,” “under,” etc., are used for clarity and convenience in understanding the disclosure and accompanying drawings and do not connote or depend on any specific preference, orientation, or order, except where the context clearly indicates otherwise.

As used herein, the term “substantially” in reference to a given parameter, property, or condition means and includes to a degree that one of ordinary skill in the art would understand that the given parameter, property, or condition is met with a degree of variance, such as within acceptable manufacturing tolerances. By way of non-limiting example, depending on the particular parameter, property, or condition that is substantially met, the parameter, property, or condition may be at least 90.0% met, at least 95.0% met, at least 99.0% met, or even at least 99.9% met.

As used herein, the term “about” in reference to a given parameter is inclusive of the stated value and has the meaning dictated by the context (e.g., it includes the degree of error associated with measurement of the given parameter).

What is claimed is:

1. A method for improving wellbore stability in a subterranean, laminated, carbonate-containing formation, where the method comprises:
obtaining:
information about the wettability characteristics and distribution of those characteristics in the formation; and
information about widths of fractures and gaps between layers in the formation and their distribution;
designing relative permeability modifier (RPM) particles by:
determining an average particle size distribution (PSD) to fit the widths of the fractures and the gaps; and
determining a suitable RPM material for the RPM particles;
introducing into the formation an aqueous fluid comprising:
water; and
a plurality of the RPM particles dispersed in the aqueous fluid; and
where the RPM particles enter the fractures and gaps and the RPM material swells upon contact with water to at least partially fill the fractures and gaps.

2. The method of claim 1 where the obtaining further comprises:
measuring subsurface core samples and taking downhole logging measurements;
determining from the subsurface core samples and downhole logging measurements information about the mineralogy wettability characteristics and distribution of those characteristics in the formation; and
determining information about widths of fractures and gaps between layers in the formation and their distribution.

3. The method of claim 2 where the logging measurements are taken by a method selected from the group consisting of nuclear magnetic resonance (NMR), micro-computed tomography (micro-CT), microscopy, downhole logging measurements, and combinations thereof.

4. The method of claim 1 where the fractures and gaps are water-wet and where the RPM particles enter the fractures and gaps which are changed to oil-wet.

5. The method of claim 1 where the fractures and gaps have an average size range between about 0.5 micron and about 5 mm.

6. The method of claim 1 where the RPM particles are selected from the group consisting of:
a core and the RPM material at least partially coats the core;
wholly made of RPM materials; and
combinations thereof.

7. The method of claim 1 where the RPM material is selected from the group consisting of:
homopolymers and copolymers of acrylamide, sulfonated or quaternized homopolymers and copolymers of acrylamide, polyvinylalcohols, polysiloxanes, hydrophilic natural gum polymers and chemically modified derivatives thereof;
crosslinked homopolymers and copolymers of acrylamide, crosslinked sulfonated or quaternized homopolymers and copolymers of acrylamide, crosslinked polyvinylalcohols, crosslinked polysiloxanes, crosslinked hydrophilic natural gum polymers and chemically modified derivatives thereof;
copolymers having a hydrophilic monomeric unit, where the hydrophilic monomeric unit is selected from the group consisting of ammonium and alkali metal salt of acrylamidomethylpropanesulfonic acid, a first anchoring monomeric unit based on N-vinylformamide and a filler monomeric unit, where the filler monomeric unit is selected from the group consisting of acrylamide and methylacrylamide; and
copolymers of vinylamide monomers and monomers containing ammonium or quaternary ammonium moieties, copolymers of vinylamide monomers and monomers comprising vinylcarboxylic acid monomers and/or vinylsulfonic acid monomers, and salts thereof, and these copolymers comprising a crosslinking monomer selected from the group consisting of bis-acrylamide, diallylamine, N,N-diallylacrylamide, divinyloxyethane, divinyldimethylsilane.

8. The method of claim 1 where the proportion of RPM particles dispersed in the aqueous fluid ranges from about 1 to about 30% by weight.

9. The method of claim 1 where the RPM particles have a PSD between about 100 nanometer to about 500,000 nanometers.

10. A method for improving wellbore stability in a subterranean, laminated, carbonate-containing formation, the method comprising:
measuring subsurface core samples and taking downhole logging measurements;
determining from the subsurface core samples and downhole logging measurements information about the mineralogy wettability characteristics and distribution of those characteristics in the formation; and
determining information about widths of fractures and gaps between layers in the formation and their distribution, where the fractures and gaps have an average size range between about 0.5 micron and about 5 mm;
designing relative permeability modifier (RPM) particles by:
determining an average particle size distribution (PSD) to fit the widths of the fractures and the gaps; and
determining a suitable RPM material for the RPM particles;
introducing into the formation an aqueous fluid comprising:
water; and
a plurality of the RPM particles dispersed in the aqueous fluid; and
where the RPM particles enter the fractures and gaps and the RPM material swells upon contact with water to at least partially fill the fractures and gaps.

11. The method of claim 10 where the logging measurements are taken by a method selected from the group consisting of nuclear magnetic resonance (NMR), micro-computed tomography (micro-CT), microscopy, downhole logging measurements, and combinations thereof.

12. The method of claim 10 where the RPM particles are selected from the group consisting of:
a core and the RPM material at least partially coats the core;
wholly made of RPM materials; and
combinations thereof.

13. The method of claim 10 where the RPM material is selected from the group consisting of:
homopolymers and copolymers of acrylamide, sulfonated or quaternized homopolymers and copolymers of acrylamide, polyvinylalcohols, polysiloxanes, hydrophilic natural gum polymers and chemically modified derivatives thereof;
crosslinked homopolymers and copolymers of acrylamide, crosslinked sulfonated or quaternized homopolymers and copolymers of acrylamide, crosslinked polyvinylalcohols, crosslinked polysiloxanes, crosslinked hydrophilic natural gum polymers and chemically modified derivatives thereof;
copolymers having a hydrophilic monomeric unit, where the hydrophilic monomeric unit is selected from the group consisting of ammonium and alkali metal salt of acrylamidomethylpropanesulfonic acid, a first anchoring monomeric unit based on N-vinylformamide and a filler monomeric unit, where the filler monomeric unit is selected from the group consisting of acrylamide and methylacrylamide; and
copolymers of vinylamide monomers and monomers containing ammonium or quaternary ammonium moieties, copolymers of vinylamide monomers and monomers comprising vinylcarboxylic acid monomers and/or vinylsulfonic acid monomers, and salts thereof, and these copolymers comprising a crosslinking monomer selected from the group consisting of bis-acrylamide, diallylamine, N,N-diallylacrylamide, divinyloxyethane, divinyldimethylsilane.

14. The method of claim 10 where the proportion of RPM particles dispersed in the aqueous fluid ranges from about 1 to about 30% by weight.

15. The method of claim 10 where the RPM particles have a PSD between about 100 nanometer to about 500,000 nanometers.

16. A method for improving wellbore stability in a subterranean, laminated, carbonate-containing formation, the method comprising:
obtaining:
information about the wettability characteristics and distribution of those characteristics in the formation; and
information about widths of fractures and gaps between layers in the formation and their distribution;
designing relative permeability modifier (RPM) particles by:
determining an average particle size distribution (PSD) to fit the widths of the fractures and the gaps, where the fractures and gaps have an average size range between about 0.5 micron and about 5 mm; and
determining a suitable RPM material for the RPM particles;
introducing into the formation an aqueous fluid comprising:
water; and
a plurality of the RPM particles dispersed in the aqueous fluid, where the RPM particles have a PSD between about 100 nanometer to about 500,000 nanometers; and
where the RPM particles enter the fractures and gaps and the RPM material swells upon contact with water to at least partially fill the fractures and gaps;
where the RPM material is selected from the group consisting of:
homopolymers and copolymers of acrylamide, sulfonated or quaternized homopolymers and copolymers of acrylamide, polyvinylalcohols, polysiloxanes, hydrophilic natural gum polymers and chemically modified derivatives thereof;
crosslinked homopolymers and copolymers of acrylamide, crosslinked sulfonated or quaternized homopolymers and copolymers of acrylamide, crosslinked polyvinylalcohols, crosslinked polysiloxanes, crosslinked hydrophilic natural gum polymers and chemically modified derivatives thereof;
copolymers having a hydrophilic monomeric unit, where the hydrophilic monomeric unit is selected from the group consisting of ammonium and alkali metal salt of acrylamidomethylpropanesulfonic acid, a first anchoring monomeric unit based on N-vinylformamide and a filler monomeric unit, where the filler monomeric unit is selected from the group consisting of acrylamide and methylacrylamide; and
copolymers of vinylamide monomers and monomers containing ammonium or quaternary ammonium moieties, copolymers of vinylamide monomers and monomers comprising vinylcarboxylic acid monomers and/or vinylsulfonic acid monomers, and salts thereof, and these copolymers comprising a crosslinking monomer selected from the group consisting of bis-acrylamide, diallylamine, N,N-diallylacrylamide, divinyloxyethane, divinyldimethylsilane.

17. The method of claim 16 where the obtaining further comprises:
measuring subsurface core samples and taking downhole logging measurements;
determining from the subsurface core samples and downhole logging measurements information about the mineralogy wettability characteristics and distribution of those characteristics in the formation; and
determining information about widths of fractures and gaps between layers in the formation and their distribution.

18. The method of claim 16 where the logging measurements are taken by a method selected from the group consisting of nuclear magnetic resonance (NMR), micro-computed tomography (micro-CT), microscopy, downhole logging measurements, and combinations thereof.

19. The method of claim 16 where the RPM particles are selected from the group consisting of:
a core and the RPM material at least partially coats the core;
wholly made of RPM materials; and
combinations thereof.

20. The method of claim 16 where the proportion of RPM particles dispersed in the aqueous fluid ranges from about 1 to about 30% by weight.
